(19) United States
(12) Patent Application Publication
(10) Pub. No.: US 2011/0180196 A1
(43) Pub. Date: Jul. 28, 2011

(54) System And Method For Making Tapered Looped Suture

(76) Inventors: Richard Casey Hart, Clinton, CT (US); Keith Kroeber, Portland, CT (US); Gary Suszynski, Woodbury, CT (US)

(21) Appl. No.: 13/051,544

(22) Filed: Mar. 18, 2011

Related U.S. Application Data
(63) Continuation-in-part of application No. 12/751,456, filed on Mar. 31, 2010.
(60) Provisional application No. 61/173,719, filed on Apr. 29, 2009.

(51) Int. Cl. B32B 37/16

(52) U.S. Cl. 156/64; 156/180; 156/378; 156/433

(57) ABSTRACT

A mounting assembly for use in forming a looped suture is provided. The anvil assembly includes a first anvil configured to operate with a welding assembly to join a first length of a thread and a second length of the thread to form a loop in the thread. The first anvil is selectively movable in at least first and second directions relative to a welding assembly. The anvil assembly may further include a second anvil configured to operate with a trimming assembly to remove excess thread from the loop, wherein the second anvil is selectively movable in at least first and second directions relative to the trimming assembly.

### CROSS-REFERENCE TO RELATED APPLICATIONS

The present application is a continuation-in-part of U.S. patent application Ser. No. 12/751,456, filed Mar. 31, 2010, which claims benefit of and priority to U.S. Provisional Application Ser. No. 61/173,719, filed Apr. 29, 2009, the disclosures of which are incorporated by reference herein in their entirety.

### BACKGROUND

1. Technical Field

The present disclosure relates to a system of forming a looped suture. More particularly, the present disclosure relates to an automated system of forming a looped suture having a tapered cut.

2. Background of Related Art

The forming of a loop in a suture is known, as are methods of forming the loop. A loop may be formed in a suture for a number of reasons. For example, during manufacture a loop may be formed in the suture to assist in further processing of the suture, e.g. for holding the suture as barbs are formed along the length thereof Alternatively, a loop formed in a suture during manufacture may be used to secure the suture to tissue. In this manner, once the non-looped end of the suture is inserted through tissue, that end may be threaded through the loop to form a slip knot-like configuration that may be tied to secure tissue. In another application, a loop may be formed in a suture in place of a knot. This requires the use of a handheld instrument that may be brought into an operating room.

Regardless of the reason for forming the loop, when a loop is formed in a suture, whether using adhesive, heat or ultrasonic energy, the diameter of the suture is doubled where the two suture portions overlap. In the event that the suture loop is used to secure tissue, the doubling of the diameter of the suture in order to create the loop increases the amount of force necessary to pull the loop through tissue. This increased force applied to the suture may result in tearing or other unnecessary trauma to the tissue being sutured. This increased force applied to the suture may also result in the overlapping portions of suture separating. Therefore, it would be beneficial to have a system and method of forming a looped suture to include a taper cut.

### SUMMARY

A mounting assembly for use in forming a looped suture is provided. The anvil assembly includes a first anvil configured to operate with a welding assembly to join a first length of a thread and a second length of the thread to form a loop in the thread. The first anvil is selectively movable in at least first and second directions relative to a welding assembly. The anvil assembly may further include a second anvil configured to operate with a trimming assembly to remove excess thread from the loop, wherein the second anvil is selectively movable in at least first and second directions relative to the trimming assembly.

In one embodiment, the first anvil is configured to be approximated towards and away from the welding assembly, to be translated laterally relative to the welding assembly and/or to be translated forwards and backwards relative to the welding assembly. The second anvil may also be configured to be approximated towards and away from the trimming assembly, to be translated laterally relative to the trimming assembly and/or to be translated forwards and backwards relative to the trimming assembly. The first anvil may include a channel configured to selectively receive at least a portion of the first length of thread. The second anvil may include a gripping mechanism for selectively gripping a portion of the thread.

Also provided is a system for forming a looped suture. The system includes a welding assembly configured for securing a loop in a thread, a trimming assembly for removing excess thread from the loop and an mounting assembly including a first anvil configured to operate with the welding assembly and a second anvil configured to operate with the trimming assembly. The first anvil is selectively movable in at least a first direction relative to the welding assembly and the second anvil is selectively movable in at least a first direction relative to the trimming assembly. The system may further include one or more of a flipper gripping assembly configured for forming a loop in the thread, a carriage assembly configured for advancing the thread through the forming process, a cutter assembly for severing the thread upon completion of the loop forming process, a thread lengthening assembly configured for extending the length of the thread and a monitoring assembly configured for monitoring the forming process.

A method of forming a looped suture is also provided. The method includes the steps of providing a system having a welding assembly, a trimming assembly and an anvil assembly, wherein the mounting assembly includes first and second anvils. The method further includes the steps of receiving a first length of thread adjacent a second length of thread between the welding assembly and the first anvil, approximating the first anvil towards the welding assembly, activating the welding assembly, joining the adjacent first and second lengths of thread and approximating the first anvil away from the welding assembly. The first anvil may be approximated towards the welding assembly until a predefined torque value is sensed by a sensor located in the anvil assembly and/or until a predefined force value is sensed by a sensor located in the welding assembly. Upon sensing the predefined torque value or force value, the anvil assembly may be approximated towards the welding assembly an additional predefined distance.

The method may further include the steps of receiving the joined first and second lengths of thread between the trimming assembly and the second anvil, approximating the second anvil towards the trimming assembly, removing excess thread from the joined first and second lengths of thread and approximating the second anvil away from the trimming assembly.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiment(s) given below, serve to explain the principles of the disclosure, wherein:

FIG. 1A is a side view of a looped suture including a tapered portion;

FIG. 1B is a cross-sectional end view of the looped suture of FIG. 1B, taken along line 1B-1B;

FIG. 1C is an enlarged side view of portion 1C of FIG. 1A;

FIG. 2 is a side view of a tapered loop forming system of the present disclosure;

FIG. 3 is an enlarged side view of a suture supply assembly of the tapered loop forming system of FIG. 2;

FIG. 4 is an enlarged sectional side view of the tapered loop forming system of FIG. 2;

FIG. 5A is an enlarged side view of alternative embodiments of the anvil and the gripping anvil of FIGS. 2, including a mounting assembly for selectively moving the respective anvils;

FIG. 5B is a perspective view of the anvils and mounting assembly of FIG. 5A;

FIG. 5C is a perspective view of the mounting assembly of FIGS. 5A and 5B;

FIG. 6 is an enlarged side view of carriage assembly of the tapered loop forming system of FIG. 2;

FIG. 7A is an enlarged cross-sectional side view of welding assembly of the loop forming system of FIG. 2, in a partially activated position; and

FIG. 7B is an enlarged cross-sectional side view of the welding assembly of FIG. 7A, in a fully activated position.

### DETAILED DESCRIPTION

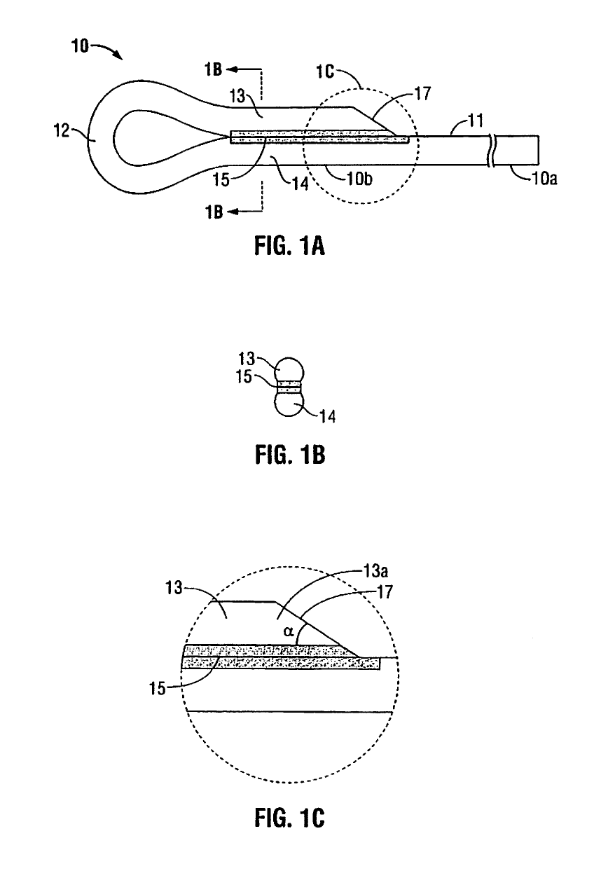

A system and method for forming a looped suture including a tapered cut is herein described. Referring initially to FIG. 1A, a looped suture formed in accordance with the method of the present disclosure is shown generally as looped suture 10. Suture 10 is formed from a monofilament thread 11, however, it is envisioned that suture 10 may be formed braided threads, multifilament threads and other surgical fibers. Although shown having a circular cross-sectional geometry, the cross-sectional geometry of thread 11 may be of any suitable shape. For example, thread 11 may be round, elliptical, square, flat, octagonal, and rectangular. Thread 11 may be formed of degradable materials, non-degradable materials, and combinations thereof. Thread 11 may be formed using any technique within the purview of those skilled in the art, such as, for example, extrusion, molding and/or solvent casting.

With reference to FIGS. 1A-1C, looped suture 10 includes a loop 12 formed on a distal end 10b thereof. Loop 12 forms a substantially teardrop shape and may be formed of any size. A first section 13 of monofilament thread 11 overlays a second section 14 of thread 11 to form loop 12. The adjacent surfaces of first and second sections 13, 14 form a joined segment or joint 15. As shown, joined segment 15 extends beyond first section 13 of thread 11. In this manner, first and second sections 13, 14 of thread 11 are less likely to separate or peel away from each other as looped suture 10 is pulled through tissue (not shown).

As will be described in further detail below, first and second sections 13, 14 of thread 11 are welded together to form joined section 15. In this manner, first and second sections 13, 14 of thread 11 are locally heated until each fuses to form joined segment 15. Various types of energy may be used to locally heat first and second sections 13, 14 to form joined segment 15, including, RF, ultrasonic, laser, electrical arc discharge, and thermal. Alternatively, first and second sections 13, 14 of thread 11 may be joined using glue, epoxy or other adhesive.

With particular reference to FIG. 1 C, a proximal end 13a of first section 13 is angled to fond a tapered surface 17. Tapered surface 17 angles downwardly towards proximal end 10a (FIG. 1A) of looped suture 10. Tapered surface 17 may form an angle between zero degrees (0°) and ninety degrees (90°), and preferably between about fifteen degrees (15°) to about sixty degrees (60°). Tapered surface 17 facilitates insertion of loop 12 into or through tissue. Tapered surface 17 may be formed prior to, during or following the joining of first and second sections 13, 14.

Although shown having a substantially planar taper, tapered surface 17 may include any number of configurations. For example, tapered surface 17 may be beveled, may include a laterally and longitudinally concave taper, may include a laterally and longitudinally convex taper, or may include any combination thereof. Tapered surface 17 may be selected depending on the tissue being sutured and/or the depth loop 12 is desired to be received within the tissue.

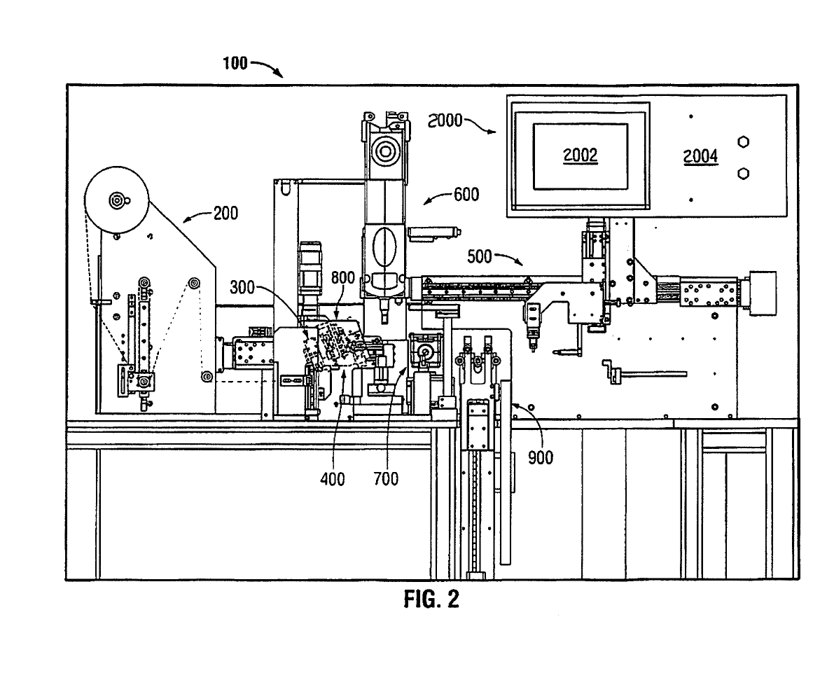

A system for forming loop 12 on distal end 10b of looped suture 10 will now be described with reference to FIGS. 2-7B, and is shown generally as tapered loop forming system 100. Although shown as being automated, it is envisioned that various components and/or process within tapered loop forming system 100 may manually completed. Referring initially to FIG. 2, system 100 includes a suture supply assembly 200, an initial gripping assembly 300, a flipper gripping assembly 400, a carriage assembly 500, a welding assembly 600, a trimming assembly 700, a cutter assembly 800, and may optionally include a thread lengthening assembly 900 and a monitoring assembly 2000.

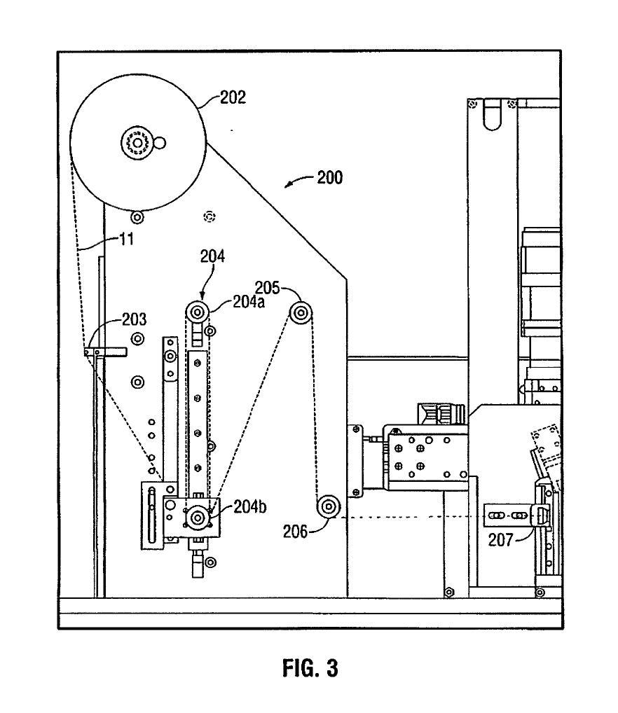

With reference now to FIG. 3, supply assembly 200 is configured to provide thread 11 to initial gripping assembly 300. Supply assembly 200 includes a spool 202, a first guide member 203, a roller assembly 204, first and second rollers 205, 206 and a second guide member 207. First guide member 203 is configured to direct thread 11 from spool 202 to roller assembly 204. Roller assembly 204 includes a set of fixed rollers 204a and a set of adjustable rollers 204b. Roller assembly 204 is configured to receive thread 11 about fixed and adjustable rollers 204a, 204b a plurality of times. As shown, rollers 204a, 204b are configured to receive thread 11 thereabout four (4) times, however, roller assembly 204 may be configured to receive thread 11 thereabout more or less than four times. First and second rollers 205, 206 are positioned to direct thread 11 through second guide member 207. Although shown including supply assembly 200 for providing a continuous supply of thread 11 from spool 202, alternative supply assemblies are know and may be modified for use with system 100. For example, thread 11 may be provided in fixed or predetermined lengths rather than continuously from a spool. In this manner, the aspects of the present disclosure should not be read as limited to the supply assembly herein disclosed.

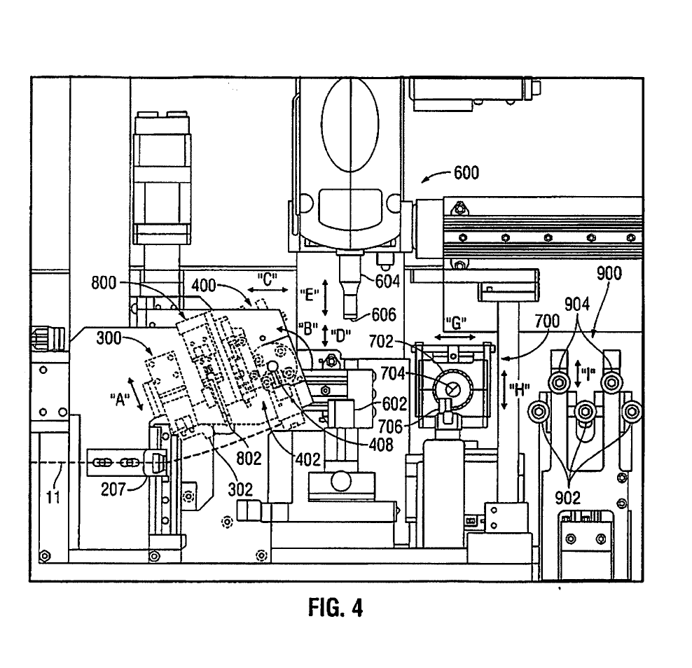

Turning now to FIG. 4, initial gripping assembly 300 includes an initial gripper 302 configured to selectively engage and selectively grasp thread 11 throughout the looped end forming process. Initial gripping assembly 300 translates on a diagonal, in the direction of arrows “A”. During the looped end forming process, initial gripping assembly 300 is activated to grasp a proximal end of thread 11 when tension is applied to a distal end of thread 11 to prevent excess thread from being pulled from supply assembly 200. In this manner, initial gripping assembly 300 may include any device or apparatus capable of selectively grasping thread 11.

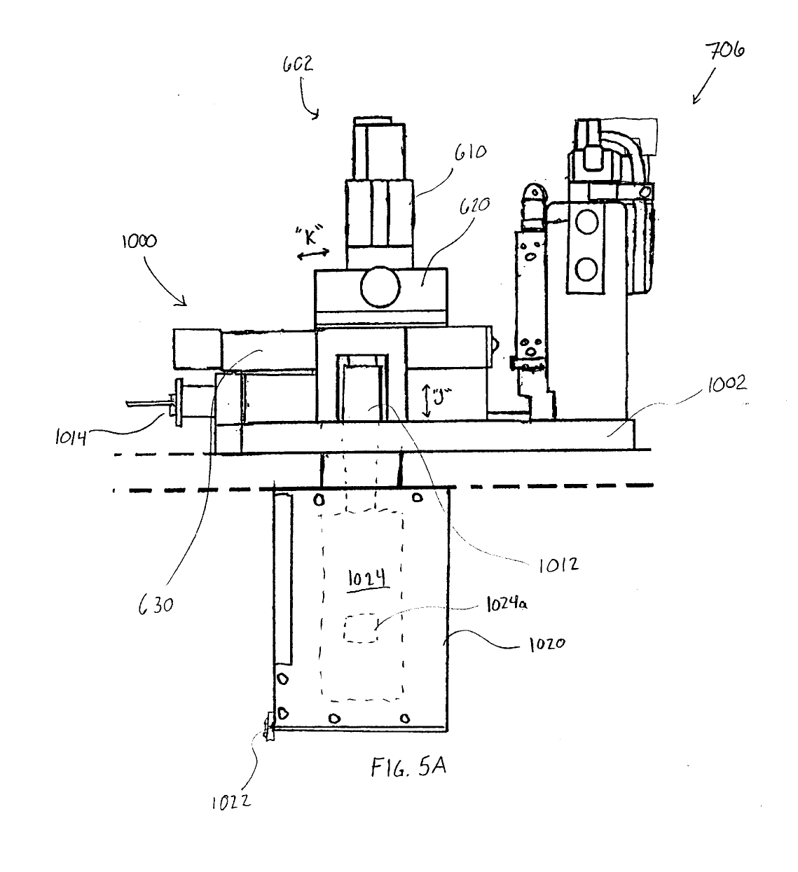

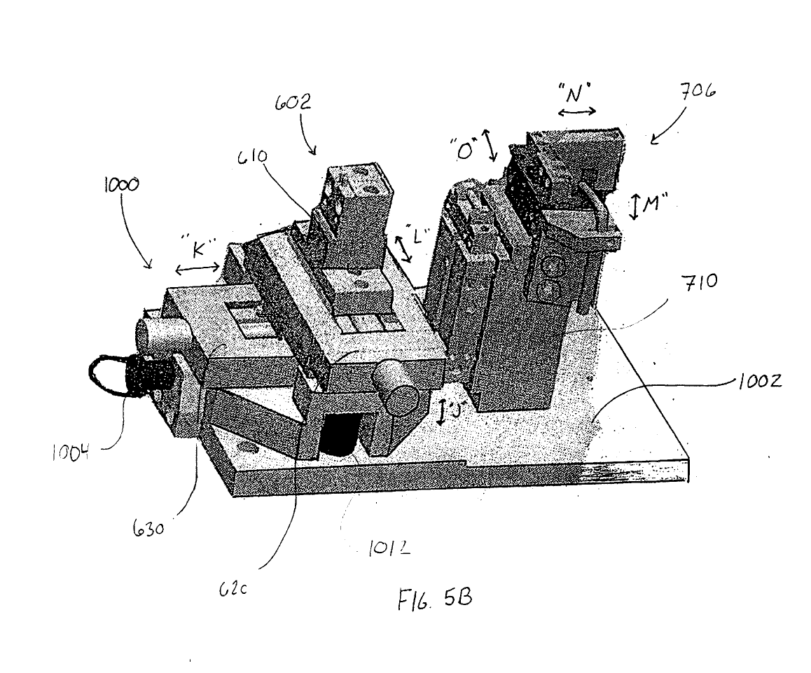

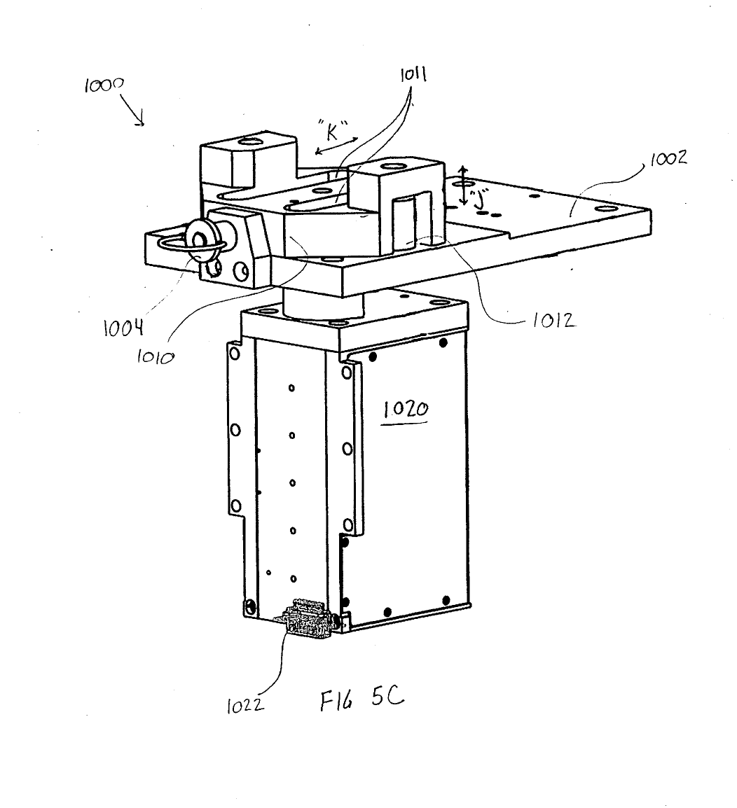

With reference still to FIG. 4, flipper gripping assembly 400 is configured to create loop 12 in thread 11. Gripping assembly 400 includes a rotating gripper 402 configured to selectively grasp a first end of thread 11. A mandrel 408 extends from rotating gripper 402 and includes a slot (not shown) configured to receive a hook 508 from carriage assembly 500 (FIG. 5). Rotating gripper 402 is configured to rotate relative to mandrel 408, in the direction of arrow “B”, to loop thread 11 around mandrel 408. Flipper gripping assembly 400 is configured to move horizontally, in the direction of arrows “C”, and vertically, in the direction of arrows “D”.

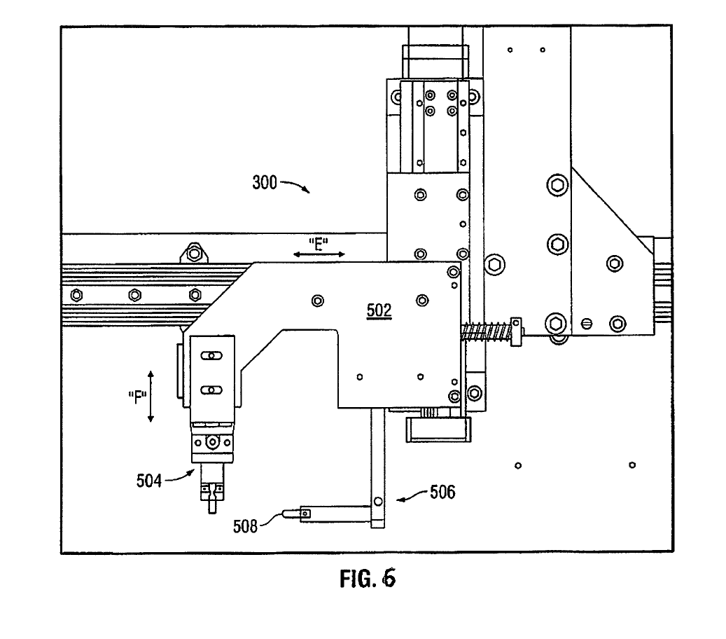

With reference now to FIG. 6, carriage assembly 500 is configured to translate thread 11 through the loop forming process. Carriage assembly 500 includes a support member 502 having a tag end gripper 504 and a hook assembly 506. A hook 508 extends from hook assembly 506 and is configured to receive thread 11 thereabout. Carriage assembly 500 optionally includes a tensioning cylinder (not shown) for tensioning thread 11 with a predetermined force to test the strength of weld 15 (FIG. 1B). Carriage assembly 500 is configured to move horizontally, in the direction of arrows “E”, and vertically, in the direction of arrows “F”.

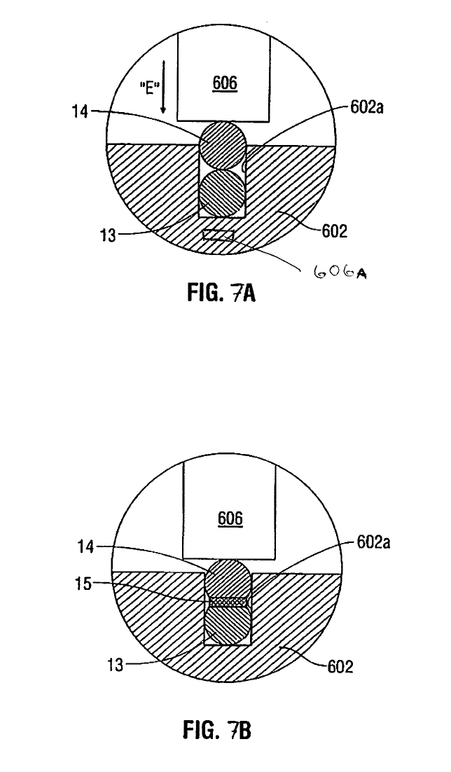

With reference back to FIG. 4, welding assembly 600 is configured to weld joined segment 15 in thread 11 to form loop 12. Welding assembly 600 includes an anvil 602 and an ultrasonic horn 604. In one embodiment, ultrasonic horn 604 includes a Branson welder horn. With reference to FIGS. 7A and 7B, ultrasonic horn 604 may include a flat die 606 configured to engage first section 13 of thread 11 during the welding step. As shown, anvil 602 defines a channel 602a configured to receive the entire width of second section 14 and more than half the width of first section 13 of thread 11. In an alternative embodiment, die 606 includes a channel (not shown) for receiving at least a portion of first section 13 of thread 11. Optionally, welding assembly 600 includes a sensor 606a (FIG. 7a), i.e., a load cell, mounted on or between ultrasonic horn 604 and/or flat die 606. As will be discussed in further detail below, feedback provided by sensor 606a may be used to effect positioning of anvil 602 prior to joining of first and second sections 13, 14 of thread 11.

Still referring to FIG. 4, trimming assembly 700 is configured to cut tapered surface 17 of looped end portion 10. Trimming assembly 700 includes an ultrasonic horn 704 having a trimming blade 702. Trimming assembly 700 further includes a gripping anvil 706 for gripping thread 11 as trimming blade 702 engages thread 11. Trimming assembly 700 is configured to move horizontally, in the direction of arrows “G”, and vertically, in the direction of arrows “H”. The rate at which trimming assembly 700 is moved horizontally and vertically affects the configuration of cut tapered surface 17. Trimming assembly 700 is further configured to be advanced and retracted. In one embodiment, trimming blade 702 is configured to be rotated one-hundred and eighty degrees (180°) such that both cutting surface thereof may be used. Although shown adapted for use as an ultrasonic cutter, trimming assembly 700 may be configured cut tapered surface 17 without the use of ultrasonic energy. In one embodiment, a laser is used to cut tapered surface 17. Alternatively, trimming blade 702 may be heated to assisted in the cutting of thread 11.

Turning to FIGS. 5A-5C, in one embodiment, anvil 602 of welding assembly 600 and gripping anvil 706 of trimming assembly 700 are each configured for selective movement relative to respective ultrasonic horn 604 (FIG. 4) and trimming blade 702 (FIG. 4). Each of anvil 602 and gripping anvil 706 are selectively mounted to a mounting assembly 1000 and are configured to move up/down, as indicated by arrows “J” and “M”, respectively, laterally, as indicated by arrows “K” and “N”, respectively, and front/back, as indicated by arrows “L” and “O”, respectively, relative to base 1002. Either or both of anvil 602 and gripping anvil 706 may be configured for movement in one or more directions prior to, during, or following the respective joining and trimming processes.

With particular reference to FIG. 5C, mounting assembly 1000 includes a substantially planar base 1002, a mounting member 1010 and a control assembly 1020. Mounting member 1010 is operably engaged with base 1002 and is configured to be raised and lowered relative to base 1002, as indicated by arrows “J”. As shown, mounting member 1010 is moved relative to base 1002 by a pair of actuators 1012. Actuators 1012 may include pneumatic or hydraulic cylinders, as shown, or any other mechanism suitable for selectively raising and/or lowering mounting member 1010 relative to base 1002. Mounting member 1010 includes a pair of longitudinal slots 1011 for selectively receiving anvil 602. Mounting assembly 1000 also includes a locking pin 1004 configured for selective engagement with mounting member 1010. Locking pin 1004 is configured to prevent movement of mounting member 1010 relative to base member 1002. Control assembly 1020 includes a motor 1024 that is operably connected to actuators 1012 and is configured to at least cause the raising and lowering of mounting member 1010. In one embodiment, motor 1024 includes a commercially available Allen Bradley servo motor. Control assembly 1020 may further include a sensor 1024a mounted on or between motor 1024 and/or actuators 1012 for providing torque feedback. As will be discussed in further detail below, the torque feedback provided by sensor 1024a may be used to position anvil 602 of anvil assembly 600 relative to ultrasonic horn 604. Control assembly 1020 may also include one or more ports 1022 for selectively connecting control assembly 1020 with monitoring assembly 2000 (FIG. 2), a command station (not shown), a power source (not shown), and/or any other device or network (not shown).

With reference still to FIGS. 5A-5C, as shown, anvil 602 includes an anvil base 610, a first translating member 620 and a second translating member 630. With particular reference to FIG. 5B, anvil base 610 operably engages first translating member 620 and is configured to be selectively positioned relative thereto, as indicated by arrows “L”. First translating member 620 operably engages second translating member 630 and is configured to be selectively positioned relative thereto, as indicated by arrows “K”. Second translating member 630 operably engages mounting member 1010 of mounting assembly 1000. As discussed above, mounting member 1010 is configured to be raised/lowered relative to base 1002.

With continued reference to FIGS. 5A-5C, gripping anvil 706 includes a multi-position base assembly 710. Base 720 is securely connected with base 1002 of mounting assembly 1000 and is configured to move gripping anvil 706 up/down, as indicated by arrows “M”, laterally, as indicated by arrows “N”, and front/back, as indicated by arrows “O”, relative to base 1002. Base assembly 710 may be operably connected to control assembly 1022, monitoring assembly 2000 (FIG. 2), a command station (not shown), a power source (not shown), and/or any other device or network (not shown).

With reference back to FIG. 4, cutter assembly 800 is configured to cut thread 11 upon completion of the looped end forming process. Cutter assembly 800 includes a cutting blade 802. Cutter assembly 800 is configured to move parallel to initial gripper assembly 300, in the direction of arrows “A”. Cutter assembly 800 is configured to cut thread 11 once thread 11 has attained an appropriate length. Cutter assembly 800 may be configured to cut a straight or tapered end on a proximal end 10a (FIG. 1A) of suture 10.

With reference to FIGS. 2 and 4, lengthening assembly 900 is configured to increase the length of thread 11 prior to thread 11 being cut by cutter assembly 800. As shown, lengthening assembly 900 includes a set of fixed rollers 902 and a set of adjustable rollers 904. Although shown including three and two rollers, respectively, sets of fixed and adjustable rollers 902, 904 may include any number of rollers. When thread 11 is received between fixed and adjustable rollers 902, 904, movement of adjustable rollers 904 relative to fixed rollers 902, in the direction of arrows “I”, causes thread 11 to lengthen. The greater the number of rollers 902, 904, the less relative movement between rollers 902, 904 is necessary to lengthen thread 11.

Monitoring assembly 2000 is configured to monitor the various steps of the looped end forming process. Monitoring assembly 2000 includes a screen 2002 and a control panel 2004.

The operation of forming station 100 will now be described with reference to 2-6B. Thread 11 extends from spool 202 through first guide member 203 before being received about roller assembly 204. Thread 11 is wrapped around fixed rollers 204a and adjustable rollers 204b of roller assembly 204 four times, and is then received about first and second rollers 205, 206 before being received through second guide member 207. The number of times thread 11 is wrapped around each rollers 204a, 206 may vary depending on the size and/or composition of thread 11.

Thread 11 extends through second guide member 207 where it is grasped by initial gripper 302 prior to being grasped by rotating gripper 402. Initial gripper 302 then releases thread 11 and flipper gripping assembly 400 translates towards anvil 602 of welding assembly 600 as carriage assembly 500 translates towards anvil 602 from the opposite direction. Flipper gripping assembly 400 and carriage assembly 500 are configured such that as carriage assembly 500 nears flipper gripping assembly 400, hook 508 of hook assembly 506 is received in the slot (not shown) of mandrel 407. Once hook 508 is received within the slot, rotating gripper 402 rotates, in the direction of arrow “B”, to loop thread 11 about mandrel 407. Flipper gripping assembly 400 and carriage assembly 500 then move to position first and second sections 13, 14 of thread 11 within channel 602a of anvil 602 (FIG. 7A). As carriage assembly 500 approximates away from flipper gripping assembly 400, hook 508 extends from within the slot formed in mandrel 407 with thread 11 received thereabout.

In one embodiment, once first and second sections 13, 14 of thread 11 are received with channel 602a (FIG. 7A) of anvil 602, ultrasonic horn 604 is activated and flat die 606 is approximate towards anvil 602, in the direction of arrow “E”. Engagement of die 606 with first section 13 of thread 11 causes first and second sections 13, 14 to weld together to form joined segment 15 (FIG. 1B). Alternatively, ultrasonic horn 604 may be positioned relative to anvil 602 prior to activating ultrasonic horn 604.

As discussed above with reference to FIGS. 5A and 5B, anvil 602 may instead, or additionally, be raised/lowered (arrows “J”), moved laterally (arrows “K”) and/or moved front/back (arrows “L”), relative to ultrasonic horn 604, to position anvil 602 relative ultrasonic horn 604. Ultrasonic horn 604 may be activated prior to, during or after positioning of anvil 602 relative to ultrasonic horn 604. The positioning of anvil 602 relative to ultrasonic horn 604 may be accomplished using any number of methods. In each of the below disclosed methods, the initial position of ultrasonic horn 604 is not important, as the movement of anvil 602 is determined by the compressive force acting on first and second sections 13, 14 of thread 11 and is not a function of the position of ultrasonic horn 604. Additionally, in each of methods, ultrasonic horn 604 is not activated until anvil 602 is stationary. In a first method, anvil 602 is moved relative to ultrasonic horn 604 until sensor 1024a in control assembly 1020 senses a predefined torque value, at which point, the movement of anvil 602 is stopped and ultrasonic horn 604 is activated. In a second method, movement of anvil 602 stops when a predefined torque value is achieved, and then anvil 602 is moved an additional user defined distance. In yet a third method, anvil 602 is moved until a force feedback provided by sensor 606a of welding assembly 600 achieves a predefined set point, at which point, the movement of anvil 602 is stopped and ultrasonic horn 604 is activated. In a fourth method, movement of anvil 602 stops when a predefined force value is achieved, and then anvil 602 is moved an additional user defined distance. The torque and/or force values and/or the additional user defined distance may vary depending on the size and type of thread being used and/or to effect different weld characteristics.

It is envisioned that ultrasonic horn 604 and anvil 602 may be moved simultaneously and/or individually to cause the forming of joined segment 15 and/or to effect the characteristics of joined segment 15 (FIG. 1A). Subsequent joining of first and second sections 13, 14 of thread 11, either or both of anvil 602 and ultrasonic horn 604 are approximated away from one another.

Once anvil 602 and ultrasonic horn 604 have been repositioned such that anvil 602 is spaced from ultrasonic horn 604, tag end gripper 504 of carriage assembly 500 grips a tag end (not shown) of thread 11 and rotating gripper 402 releases thread 11. Carriage assembly 500 then moves to position welded first and second section 13, 14 of thread 11 within gripping anvil 706 of trimming assembly 700. Gripping anvil 706 maintains thread 11 as blade 704 of ultrasonic horn 702 is moved to cut tapered surface 17 (FIG. 1A) into first section 13 of thread 11. Alternatively, and discussed above with reference to FIGS. 5A and 5B, during forming of cut tapered surface 17, gripping anvil 706 may be raised/lowered (arrows “J”), moved laterally (arrows “K”), and/or moved front/back (arrows “L”), relative to trimming blade 702, to affect the characteristics of cut tapered surface 17 (FIG. 1A). Gripping anvil 706 then releases thread 11 and carriage assembly 500 continues to translate away from supply assembly 200 to extend the length of thread 11. In is envisioned that ultrasonic horn 702 and gripping anvil 706 may be moved simultaneously and/or individually to form cut tapered surface 17. Cutting assembly 900 is then activated to cut thread 11. Prior to the cutting of thread 11, tension is applied to loop 12 (FIG. 1A) of thread 11 by the tensioning cylinder (not shown) located within carriage assembly 500 to test the strength of weld 15. Optionally, thread 11 may engage lengthening assembly 800 to extend the length of thread 11 prior to cutting.

Although the illustrative embodiments of the present disclosure have been described herein with reference to the accompanying drawings, it is to be understood that the disclosure is not limited to those precise embodiments, and that various other changes and modifications may be effected therein by one skilled in the art without departing from the scope or spirit of the disclosure. For example, it is envisioned that system 100 may include more than one welding assembly 600 and/or trimming assembly 700 to produce more than one suture 10 per activation.

What is claimed is:

1. A mounting assembly for use in forming a looped suture, the anvil assembly comprising:
a first anvil configured to operate with a welding assembly to join a first length of a thread and a second length of the thread to form a loop in the thread, wherein the first anvil is selectively movable in at least first and second directions relative to a welding assembly.

2. The anvil assembly of claim 1, further comprising:
a second anvil configured to operate with a trimming assembly to remove excess thread from the loop, wherein the second anvil is selectively movable in at least first and second directions relative to the trimming assembly.

3. The anvil assembly of claim 1, wherein the first anvil is configured to be approximated towards and away from the welding assembly.

4. The anvil assembly of claim 1, wherein the first anvil is configured to translate laterally relative to the welding assembly.

5. The anvil assembly of claim 1, wherein the first anvil is configured to translate forwards and backwards relative to the welding assembly.

6. The anvil assembly of claim 2, wherein the second anvil is configured to be approximated towards and away from the trimming assembly.

7. The anvil assembly of claim 2, wherein the second anvil is configured to translate laterally relative to the trimming assembly.

8. The anvil assembly of claim 2, wherein the second anvil is configured to translate forwards and backwards relative to the trimming assembly.

9. The anvil assembly of claim 1, wherein the first anvil includes a channel configured to selectively receive at least a portion of the first length of thread.

10. The anvil assembly of claim 1, wherein the second anvil includes gripping mechanism for selectively gripping a portion of the thread.

11. A system for forming a looped suture, the system comprising:
a welding assembly configured for securing a loop in a thread;
a trimming assembly for removing excess thread from the loop; and
an mounting assembly including a first anvil configured to operate with the welding assembly and a second anvil configured to operate with the trimming assembly, wherein the first anvil is selectively movable in at least a first direction relative to the welding assembly and the second anvil is selectively movable in at least a first direction relative to the trimming assembly.

12. The system of claim 11, further comprising one or more of:
a flipper gripping assembly configured for forming a loop in the thread;
a carriage assembly configured for advancing the thread through the forming process;
a cutter assembly for severing the thread upon completion of the loop forming process;
a thread lengthening assembly configured for extending the length of the thread; and
a monitoring assembly configured for monitoring the forming process.

13. A method of forming a looped suture, the method comprising:
providing a system including a welding assembly, a trimming assembly and an anvil assembly, wherein the mounting assembly includes first and second anvils;
receiving a first length of thread adjacent a second length of thread between the welding assembly and the first anvil;
approximating the first anvil towards the welding assembly;
activating the welding assembly;
joining the adjacent first and second lengths of thread; and
approximating the first anvil away from the welding assembly.

14. The method of claim 13, wherein the first anvil is approximated towards the welding assembly until a predefined torque value is sensed by a sensor located in the anvil assembly.

15. The method of claim 13, wherein the first anvil is approximated towards the welding assembly until a predefined force value is sensed by a sensor located in the welding assembly.

16. The method of claim 14, wherein the first anvil is approximated towards the welding assembly a predefined distance subsequent to the predefined torque value being sensed.

16. The method of claim 15, wherein the first anvil is approximated towards the welding assembly a predefined distance subsequent to the predefined force value being sensed.

17. The method of claim 13, further comprising the steps of
receiving the joined first and second lengths of thread between the trimming assembly and the second anvil;
approximating the second anvil towards the trimming assembly;
removing excess thread from the joined first and second lengths of thread; and
approximating the second anvil away from the trimming assembly.
